(19) United States
(12) Patent Application Publication
(10) Pub. No.: US 2019/0054900 A1
(43) Pub. Date: Feb. 21, 2019

(54) WINDSCREEN WIPER DEVICE

(71) Applicant: FEDERAL-MOGUL S.A., AUBANCE (BE)

(72) Inventor: ARTHUR TAILLARD, HERSERANGE (FR)

(21) Appl. No.: 16/079,227

(22) PCT Filed: Feb. 24, 2016
(86) PCT No.: PCT/EP2016/053884

§ 371 Date: Aug. 23, 2018

(51) Int. Cl. B60S 1/34; B60S 1/38

(52) U.S. Cl. CPC B60S 1/3484; B60S 1/3454; B60S 2001/3825; B60S 1/38; B60S 1/3427

(57) ABSTRACT

A windscreen wiper device (1), particularly for automobiles, includes an elongated wiper blade of a flexible material, which can be placed in abutment with a windscreen to be wiped, as well as an oscillating arm (4) near one end thereof being pivotally connectable to the wiper blade and near the other end thereof being connected to a mounting head (2) on a drive shaft (3) for transferring a reciprocal movement to the wiper blade. The oscillating arm (4) is pivotally connected to the mounting head (2) along a transverse pivot axis (14) between a wiping position, wherein the oscillating arm (4) extends substantially parallel to a windscreen to be wiped, and an elevated position, wherein the oscillating arm (4) extends away from a windscreen to be wiped. A cap portion (12) is formed as one piece with the oscillating arm and covers the mounting head (2) and a channel portion (13) extending between the cap portion (12) and the wiper blade. The pivot axis (14) is located near a side of the mounting head (2) facing away from the wiper blade.

### BACKGROUND

### 1. Technical Field

The present invention relates to a windscreen wiper device, particularly for automobiles, comprising an elongated wiper blade of a flexible material, which can be placed in abutment with a windscreen to be wiped, as well as an oscillating arm near one end thereof being pivotally connected to the wiper blade and near the other end thereof being connected to a mounting head on a drive shaft for transferring a reciprocal movement to the wiper blade, wherein the oscillating arm is pivotally connected to the mounting head along a transverse pivot axis between a wiping position, wherein the oscillating arm extends substantially parallel to a windscreen to be wiped, and an elevated position, wherein the oscillating arm extends away from a windscreen to be wiped.

The present invention also refers to an oscillating arm as such to he used in a windscreen wiper device according to the present invention.

It is noted that the present invention is not restricted to automobiles, but also refers to rail coaches and other (fast) vehicles.

### 2. Related Art

Such a windscreen wiper device is generally known. The oscillating arm is pivotally connected to the mounting head by means of a pivot pin, for example in the form of a rivet. The oscillating arm can be pivoted between a wiping position (or “working position”), wherein the oscillating arm extends parallel to a windscreen to be wiped, and an elevated or upright position (or “service position”), wherein the oscillating arm and/or the wiper blade to be attached thereto can be repaired or replaced. A spring is hooked with its first end on the mounting head and with its second end onto the oscillating arm in order to ensure that the oscillating arm and thus the wiper blade connected thereto is pressed onto a windscreen to be wiped. In use, the shaft rotates alternately in a clockwise and in a counter-clockwise sense carrying the mounting head into rotation also, which in turn draws the oscillating arm into rotation and thus moves the wiper blade.

A disadvantage of the known windscreen wiper device is the following. The oscillating arm has a U-shaped cross-section near the pivot pin comprising two side walls, wherein the side walls extend between a part of the mounting head and beyond the pivot pin. The part of the mounting head is provided with opposite surfaces. The opposite surfaces of the mounting head and the sidewalls of the oscillating arm are spaced-apart, i.e. placed at a certain distance from each other. A cap is mounted on top of the mounting head. However, in practice it has become apparent that in cold conditions, such as in freezing conditions, for example in winter time, snow and/or ice may leak into a gap between the cap and the oscillating arm and between the sidewalls of the oscillating arm and the opposite surfaces of the mounting head. As a consequence, wiping properties are deteriorated. Also, the oscillating arm may be prevented from being pivoted into the service position by snow and/or ice entered into the gap, resulting in the inability to repair or replace the oscillating arm and/or the wiper blade to be attached thereto.

### SUMMARY

The object of the invention is to provide an improved windscreen wiper device. More in particular, the present invention aims to keep the wiping properties of the wiper blade thereof at a constant high level, also in cold (freezing) conditions.

In order to accomplish that objective a windscreen wiper device of the type mentioned in the preamble is characterized according to the invention in that the oscillating arm comprises in one piece therewith a cap portion covering the mounting head and a channel portion extending between the cap portion and the wiper blade, wherein the pivot axis is located near a side of the mounting head facing away from the wiper blade. In other words, the oscillating arm is a one piece wiper arm consisting of a cap portion covering the mounting head and channel portion carrying the wiper blade, without gaps in between. A pivotal movement of the oscillating arm between a wiping position and a service position is then realized around a transverse pivot axis inside the cap portion between sidewalls thereof, i.e. perpendicular to a longitudinal direction of the channel portion of the oscillating arm. The use of a one piece oscillating arm according to the invention also has the advantage that any colour differences thereof under the influence of UV-light, for example, like in the prior art between the separate cap and the separate oscillating arm, is avoided. It is noted that in the prior art the separate cap and the separate oscillating arm are often made of different materials, mutually differing in rigidity, for example, with different ageing characteristics. Consequently, according to the present invention any additional painting of the oscillating arm like in the prior art to avoid these colour differences, is avoided as well.

The channel portion is preferably provided with an integrated washing liquid system in order to spray washing liquid onto the windscreen to be wiped.

In a preferred embodiment of a windscreen wiper device in accordance with the present invention the oscillating arm is detachably connected to the mounting head. Preferably, the cap portion is snapped onto the mounting head.

In another preferred embodiment of a windscreen wiper device according to the present invention the mounting head comprises transverse bushes forming the pivot axis, wherein the hushes at both ends thereof are pivotally connected to protrusions of sidewalls of the cap portion. In the alternative, the cap portion comprises a transverse pivot pin forming the pivot axis, wherein the pivot pin is pivotally connected to mounting the head. Therefore, it is made possible to have a higher torque at the location of the interconnection of the mounting head and the oscillating arm than in the prior art, resulting in less stress at that location (because there is a bigger distance between two pivot points).

In another preferred embodiment of a windscreen wiper device in accordance with the present invention the mounting head is entirely disposed inside the cap portion. Hence, the mounting head is invisible from the outside, whereas it is not exposed to foreign influences, such as dust, snow, ice, wind, UV-light etcetera. This results in a longer lifespan of the mounting head.

In another preferred embodiment of a windscreen wiper device according to the present invention the channel portion has a U-shaped cross-section. The cap portion may also have a U-shaped cross-section, wherein legs of the U-shaped cross-section form the sidewalls of the cap portion between which the pivot axis/pivot pin extends.

In another preferred embodiment of a windscreen wiper device in accordance with the present invention a traction spring is disposed inside the oscillating arm, wherein the traction spring at one end thereof engages the mounting head and at the other end thereof engages the oscillating arm. Particularly, the spring engages a protrusion extending downwardly from a base of a U-shaped cross-section of the channel portion. More in particular, the traction spring comprises a stop surface for limiting a maximum rotation angle of a pivotal movement of the oscillating arm.

In another preferred embodiment of a windscreen wiper device according to the present invention the oscillating arm or the mounting head comprises a stop surface for limiting a maximum rotation angle of a pivotal movement of the oscillating arm.

In another preferred embodiment of a windscreen wiper device in accordance with the present invention the oscillating arm comprises in one piece therewith a elastic finger, wherein the elastic finger cooperates with a longitudinally extending tooth on the mounting head in order to retain the oscillating arm in the wiping position when a lifting force is exerted thereon under driving conditions. In other words, under driving conditions the mutual cooperating finger (preferably extending downwardly from a base of a U-shaped cross-section of the channel portion) and the tooth on the mounting head are able to withstand the lifting force, so that the the oscillating arm is retained in the wiping position. On the other hand, due to the elasticity of the elastic finger, the oscillating arm can be easily pivoted by hand from the wiping position into the service position.

In another preferred embodiment of a windscreen wiper device according to the present invention the wiper blade is of the flat blade type and includes at least one groove, in which groove a longitudinal strip of an elongated, elastic carrier element is disposed, and wherein the channel portion near one end thereof is pivotally connected to the wiper blade with the interposition of a connecting device. However, it is noted that the present invention is not restricted to the use of only one longitudinal strip, also called “flexor”, that is particularly located in a central, channel forming groove of the wiper blade. Instead, the carrier element may comprise two, spaced-apart longitudinal strips forming the elastic, elongated carrier element, wherein the strips are disposed in opposing longitudinal grooves on longitudinal sides of the wiper blade, in the latter case the connecting device, also called “connector”, may welded, soldered, brazed or glued to the longitudinal strips. In the former case, the connecting device may be welded, soldered, brazed or glued to an elastomeric material, such as rubber, of the wiper blade.

As the above, the present invention also relates to an oscillating arm for a windscreen wiper device, particularly for automobiles, which near one end thereof is arranged to be pivotally connected to a wiper blade and which near the other end thereof is arranged to be connected to a mounting head on a drive shaft for transferring a reciprocal movement to the wiper blade, wherein the oscillating arm is arranged to be pivotally connected to the mounting head along a transverse pivot axis between a wiping position, wherein the oscillating arm extends substantially parallel to a windscreen to be wiped, and an elevated position, wherein the oscillating arm extends away from a windscreen to be wiped, characterized in that the oscillating arm comprises in one piece therewith a cap portion covering the mounting head and a channel portion extending between the cap portion and the wiper blade, wherein the pivot axis is located near a side of a mounting location for the mounting head facing away from a mounting location for the wiper blade, the oscillating arm is preferably made of a metallic material.

### THE DRAWINGS

The invention will now be explained in more detail with reference to figures illustrated in a drawing, wherein

FIG. 1A is a perspective view, a side view, a top view and a bottom view of a windscreen wiper device according to the prior art, without a wiper blade;

FIG. 1B corresponds to FIG. 1A, but now shown with parts disassembled;

FIG. 2A corresponds to FIG. 1 and is a perspective view, a side view, a top view and a bottom view of a windscreen wiper device according to the invention, without a wiper blade;

FIG. 2B corresponds to FIG. 2A, but now depicted with parts disassembled;

FIG. 3 is a side view of a windscreen wiper device of FIG. 1 with the oscillating arm in elevated position;

FIG. 4 is a side view and a perspective view from below of a windscreen wiper device of FIG. 2 with the oscillating arm in elevated position;

FIG. 5 is a side view of a windscreen wiper device of FIG. 2 with the oscillating arm in elevated position, partly cut away;

FIGS. 6 and 7 are details of FIG. 5 in side view and (partly) cut away;

FIG. 8 shows several side views of a windscreen wiper device of FIG. 2 with the oscillating arm turned down in wiping position; and

FIG. 9 is a perspective view, seen from below, of a part of the windscreen wiper device of FIG. 2, but equipped with a washing liquid system.

### DETAILED DESCRIPTION

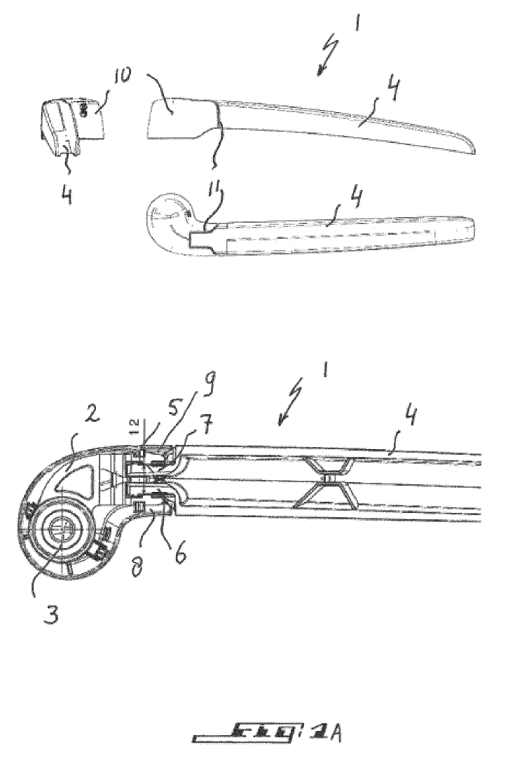

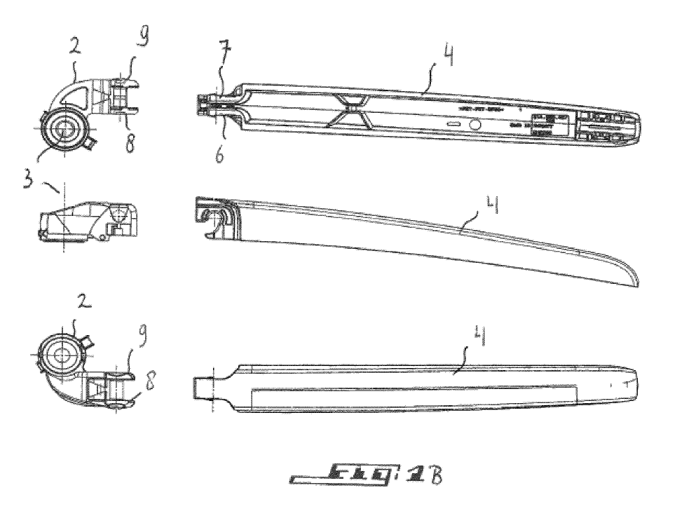

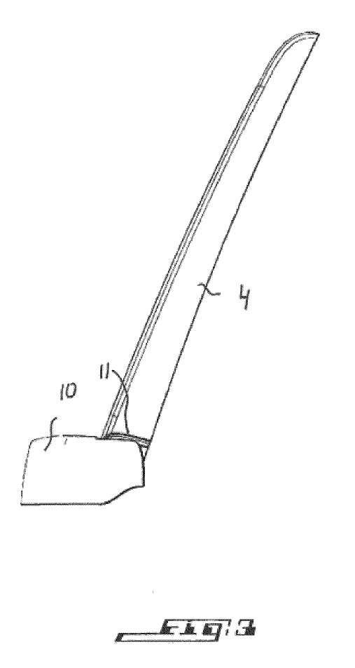

FIGS. 1 and 3 show a windscreen wiper device 1 according to the prior art, without a wiper blade of the flat blade type. As illustrated, the windscreen wiper device 1 according to the prior art comprises a mounting head 2 which can he fixed for rotation to a shaft 3 driven, via a mechanism not illustrated, by a small motor. the windscreen wiper device 1 further comprises an oscillating arm 4 supported by the mounting head 2, wherein the oscillating arm 4 in turn supports a wiper blade (not shown) with the help of a connecting device (not shown). The oscillating arm 4 is pivotally connected to the mounting head 2 by means of a pivot pin 5, for example in the form of a rivet. A spring (not shown) is hooked with its first end on the mounting head 2 and with its second end on to the oscillating arm 4 in order to ensure that the oscillating arm 4 and thus the wiper blade connected thereto is pressed onto a windscreen to be wiped. In use, the shaft 3 rotates alternately in a clockwise and in a counter-clockwise sense carrying the mounting head 2 into rotation also, which in turn draws the oscillating arm 4 into rotation and by means of the connecting device moves the wiper blade.

As illustrated, the oscillating arm 4 has a substantially U-shaped cross-section near the pivot pin 5 comprising two side walls 6, 7, wherein the side walls 6, 7 extend between a part of the mounting head 2 and beyond the pivot pin 5. The part of the mounting head 2 is provided with opposite surfaces 8, 9. The opposite surfaces 8, 9 of the mounting head 2 and the sidewalls 6, 7 of the arm member 4 are spaced-apart, i.e. placed at a certain distance.

As indicated above, the oscillating arm 4 is pivotally connected to the mounting head 2 by means of the pivot pin 5, wherein the oscillating arm 4 can be pivoted between a wiping position (or “working position”; see FIG. 1), wherein the oscillating arm 4 extends parallel to a windscreen to be wiped, and an elevated or upright position (or “service position”; see FIG. 3), wherein the oscillating arm 4 and/or a windscreen wiper blade to be attached thereto can be repaired or replaced.

Again with reference to FIGS. 1 and 3, the windscreen wiper device 1 according to the prior art comprises a separate cap 10 mounted onto the mounting head 2. Due to the different materials used for the oscillating arm 4 and the cap 10, as far as rigidity is concerned, for example, these materials have different ageing characteristics, resulting in colour differences. An extra painting step to obviate this disadvantage is costly and cumbersome. Further, a gap 11 is formed between the oscillating arm 4 and the cap 10 which is open for dust, ice, snow etcetera.

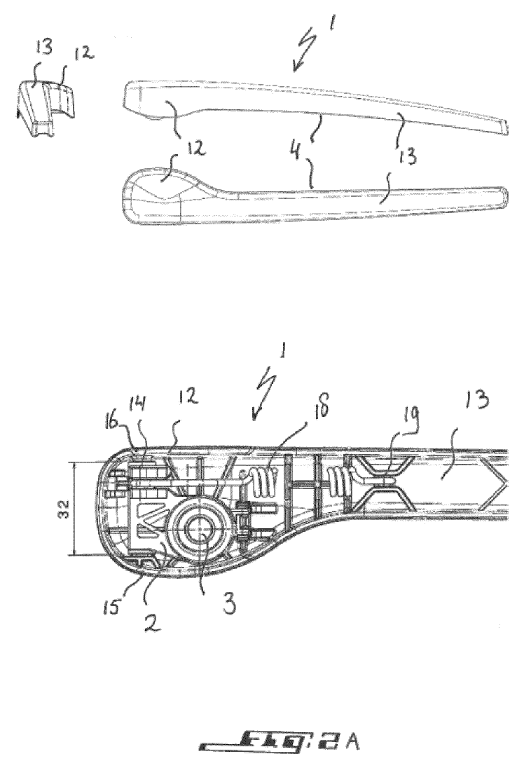

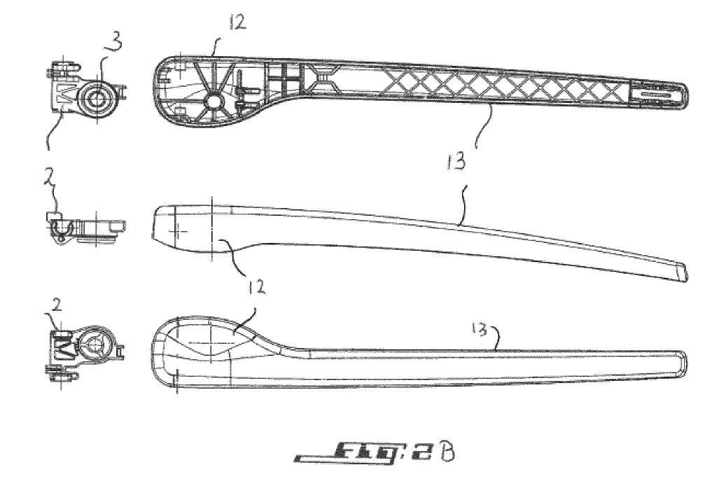

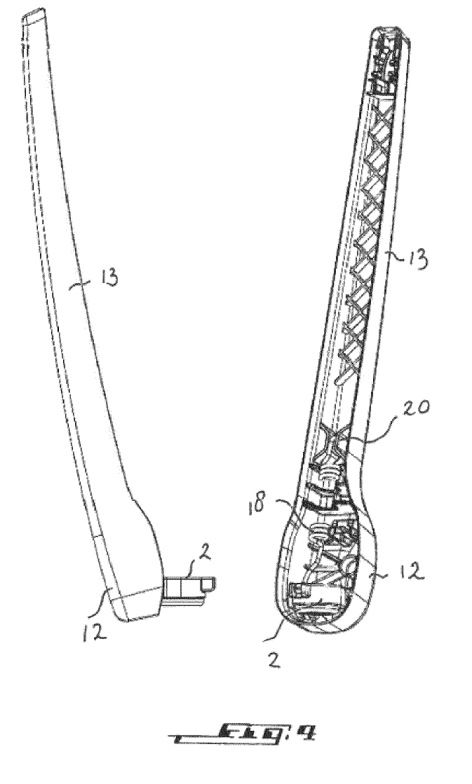

FIGS. 2 and 4 correspond to FIGS. 1 and 3, but now relating to a windscreen wiper device 1 according to the invention, wherein corresponding parts have been designated with the same reference numerals. The oscillating arm 4 is now a one piece wiper arm made of plastic, for example, consisting of a cap portion 12 at the location of its connection to the mounting head 2 and a channel portion 13 extending between the cap portion 12 and a wiper blade (not shown), both having a U-shaped cross-section and all in one piece of material. As illustrated, the mounting head 2 is entirely located inside the cap portion 12. the oscillating arm 4 is detachably and pivotally connected to the mounting head 2 along a transverse pivot axis 14 extending between sidewalls 15,16 of the cap portion 12 between a wiping position (see FIG. 2) and an elevated position (see FIG. 4). In this case the mounting head 2 comprises a transverse pivot pin or two pivot bushes 17 forming the pivot axis 14, whereas the pivot bushes 17 at both ends thereof are pivotally connected to protrusions of the sidewalk 15, 16 of the cap portion 12. Comparing FIGS. 1 (prior art) and 2 (invention) it is noted that the articulation width in the prior art is about 12 mm and in the present invention is about 32 mm, thus a higher torque and less stress is exerted on the articulation according to the present invention. A traction spring 18 disposed inside the oscillating arm 4 at one end thereof engages a pin 19 of the mounting head 2 and at the other end thereof engages a protrusion 20 extending downwardly from a base of the U-shaped cross-section of the channel portion 13 of the osculating arm 4.

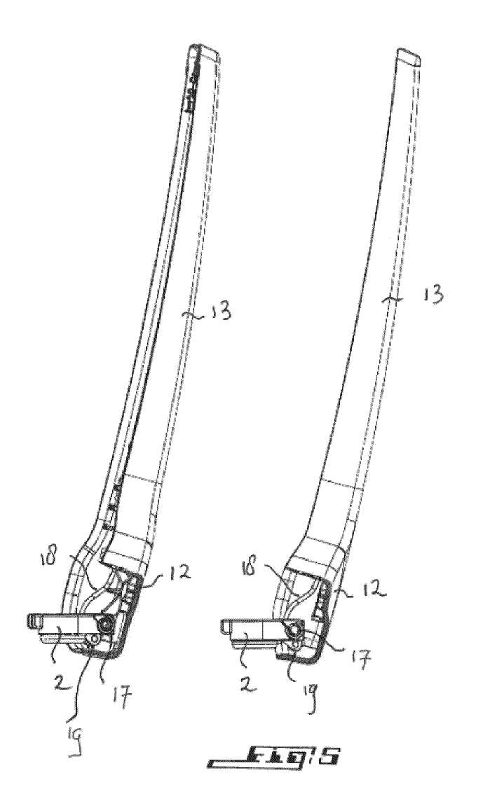

FIGS. 5 through 8 correspond to FIGS. 2 and 4, but now relating to several views, partly cut out, of the windscreen wiper device 1 according to the invention, wherein corresponding parts have been designated with the same reference numerals,

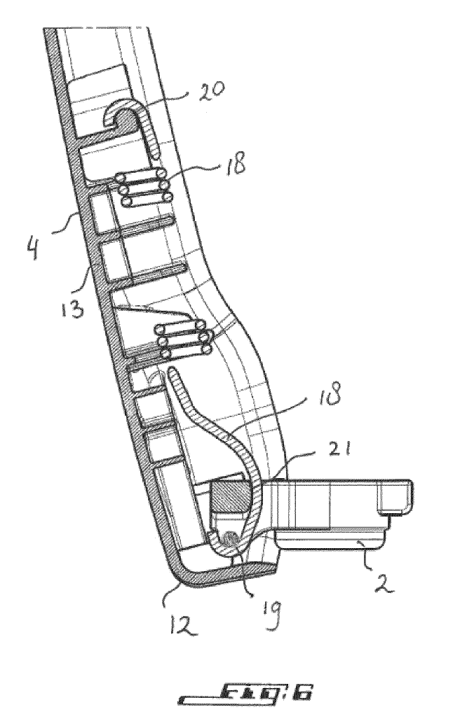

In order to limit a maximum rotation angle of a pivotal movement of the oscillating arm 4 from the wiping position to the service position, two stop surfaces have been provided for: a stop surface 21 on the traction spring 18 on the one hand (see FIG. 6) and a stop surface 22 on the cap portion 12 on the other hand (see detail A of FIG. 7).

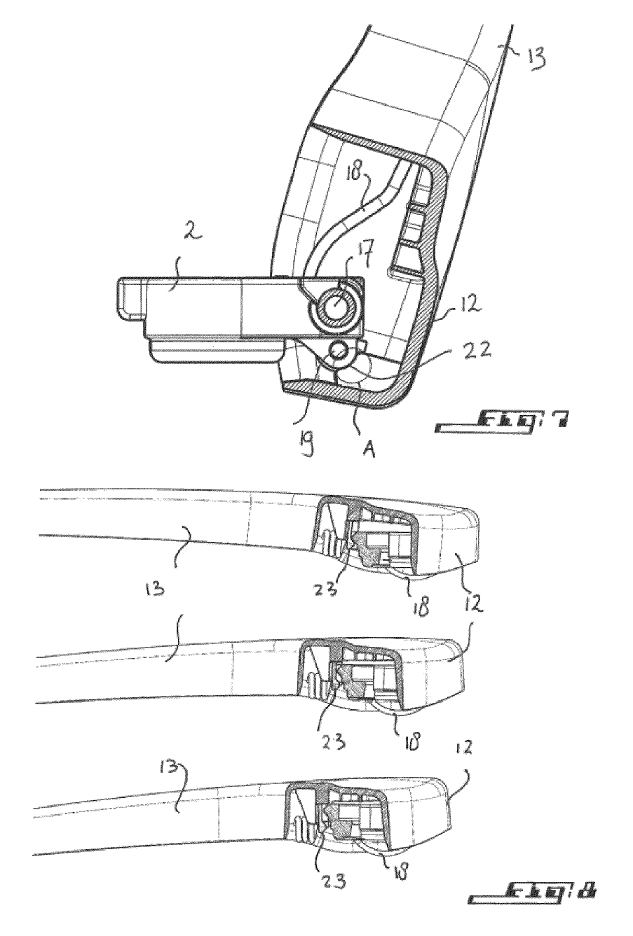

In order to retain the oscillating arm 4 in the wiping position also in case a lifting force is exerted thereon under driving conditions, an elastic finger 23 extending downwardly from a base of the U-shaped cross-section of the cap portion 12 is foreseen cooperating with a longitudinally extending tooth 24 on the mounting head 2, wherein reference is made to FIG. 8. The mutual cooperating finger 23 and the tooth 24 are able to withstand the lifting force, so that the oscillating arm 4 is retained in the wiping position. On the other hand, due to the elasticity of the elastic finger 23, the oscillating arm 4 can be easily pivoted by hand from the wiping position (see FIG. 8) into the service position (see FIG. 4).

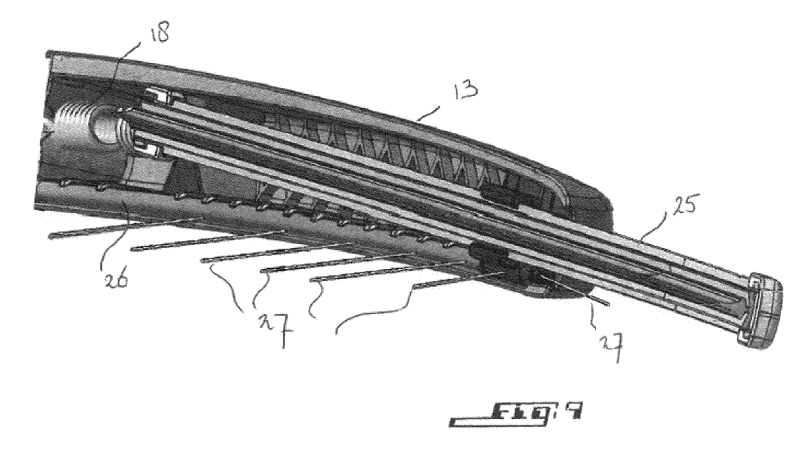

FIG. 9 refers to a perspective view, seen from below, of the channel portion 13 holding a wiper blade 25 of the flat blade type. Inside the channel 25 a washing liquid conduit 26 is mounted in order to spray washing liquid 27 onto a windscreen to be wiped.

The present invention is not restricted to the embodiments shown, but extends also to other preferred embodiments falling within the scope of the appended claims.

1. A windscreen wiper device, comprising a wiper arm having one end thereof pivotally connectable to a wiper blade and an opposite end thereof connected to a mounting head that is mountable on a drive shaft for transferring a reciprocal movement to said wiper arm, wherein said arm is pivotally connected to said mounting head along a transverse pivot axis between a wiping position, wherein said arm extends substantially parallel to a windscreen to be wiped, and an elevated position, wherein said arm extends away from a windscreen to be wiped, and further wherein said arm comprises in one piece therewith a cap portion covering said mounting head and a channel portion extending between said cap portion and said opposite end, wherein said pivot axis is located near a side of said mounting head facing away from a side to which the wiper blade is mounted.

2. A windscreen wiper device according to claim 1, wherein said arm is detachably connected to said mounting head.

3. A windscreen wiper device according to claim 2, wherein said cap portion is snapped onto said mounting head.

4. A windscreen wiper device according to claim 1, wherein said mounting head comprises transverse bushes forming said pivot axis, and wherein said bushes at both ends thereof are pivotally connected to protrusions of sidewalls of said cap portion.

5. A windscreen wiper device according to claim 1, wherein said cap portion comprises a transverse pivot pin forming said pivot axis, and wherein said pivot pin is pivotally connected to said mounting head.

6. A windscreen wiper device according to claim 1, wherein said mounting head is entirely disposed inside said cap portion.

7. A windscreen wiper device according to claim 1, wherein said channel portion has a U-shaped cross-section.

1. A windscreen wiper device according to claim 7, wherein said cap portion has a U-shaped cross-section.

9. A windscreen wiper device according to claim 1, wherein a traction spring is disposed inside said oscillating arm, and wherein said traction spring at one end thereof engages said mounting head and at the other end thereof engages said arm.

10. A windscreen wiper device according to claim 9, wherein said traction spring comprises a stop surface for limiting a maximum rotation angle of a pivotal movement of the arm.

11. A windscreen wiper device according to claim 1, wherein said arm or said mounting head comprises a stop surface for limiting a maximum rotation angle of a pivotal movement of the arm.

12. A windscreen wiper device according to claim 1, wherein said arm comprises in one piece therewith a elastic finger, and wherein said elastic finger cooperates with a longitudinally extending tooth on said mounting head in order to retain said arm in said wiping position when a lifting force is exerted thereon under driving conditions.

13. A windscreen wiper device according to claim 1, wherein said device includes said wiper blade which is of the flat blade type and includes at least one groove, in which groove a longitudinal strip of an elongated, elastic carrier element is disposed, and wherein said channel portion near one end thereof is pivotally connected to said wiper blade with the interposition of a connecting device.

14. An oscillating arm for a windscreen wiper device, which near one end thereof is arranged to be pivotally connected to a wiper blade and which near the other end thereof is arranged to be connected to a mounting head on a drive shaft for transferring a reciprocal movement to said wiper blade, wherein said oscillating arm is arranged to be pivotally connected to said mounting head along a transverse pivot axis between a wiping position, wherein said oscillating arm extends substantially parallel to a windscreen to be wiped, and an elevated position, wherein said oscillating arm extends away from a windscreen to be wiped, wherein said oscillating arm comprises in one piece therewith a cap portion arranged to cover said mounting head and a channel portion extending between said cap portion and said wiper blade, wherein said pivot axis is located near a side of a mounting location for said mounting head facing away from a mounting location for said wiper blade.

15. An oscillating arm according to claim 14, wherein said oscillating arm is made of a metallic material.
